(19) United States
(12) Patent Application Publication
(10) Pub. No.: US 2009/0218891 A1
(43) Pub. Date: Sep. 3, 2009

(54) METHOD AND APPARATUS FOR RFID BASED SMART SENSORS

(76) Inventor: Norman D. McCollough, JR., Sharon, NH (US)

Correspondence Address: PATENT GROUP;C/O DLA PIPER US LLP, 203 N. LASALLE ST., SUITE 1900, CHICAGO, IL, 60601, US

(21) Appl. No.: 12/395,111

(22) Filed: Feb. 27, 2009

Related U.S. Application Data
(60) Provisional application No. 61/032,528, filed on Feb. 29, 2008.

(51) Int. Cl. H02J 17/00

(52) U.S. Cl. 307/154

(57) ABSTRACT

RFID devices can be powered by one or more sources of RF energy, including available RF energy. RFID devices can be utilized to measure data, or receive data transmitted to the RFID device, and can preferably store the data and transmit the data to an RFID reader or other data receiver. In some examples, RFID devices can include one or more sensors that can measure data. In other examples, RFID devices can receive data transmitted from a remote data gathering device. In some examples, the RFID devices also include data logging capabilities, and can store data that corresponds to one or more data readings.

### RELATED APPLICATIONS

This application claims the benefit of U.S. Provisional Patent Application Ser. No. 61/032,528, entitled “Method and Apparatus for RFID Smart Sensors,” filed on Feb. 29, 2008, currently pending.

### BACKGROUND

Radio frequency identification (RFID) based sensors of the present technology can be utilized in the field of monitoring, detecting, tracking, and reporting at least one specific sensor based parameter. Such RFID sensors can be utilized in applications including, for example, electrical, chemical, biological, radiological, environmental, or intrusion sensing.

RFID is an automatic identification method, relying on storing and remotely retrieving data using devices called RFID tags or transponders. The technology generally utilizes an RFID reader and an RFID tag. An RFID tag can be applied to or incorporated into a product, animal, or person for the purpose of identification and tracking. Most RFID tags contain an integrated circuit for storing and processing information, as well as for modulating and demodulating a radio-frequency (RF) signal sent to or received from the reader, and an antenna for receiving and transmitting the RF signal. There are generally two types of RFID tags: active RFID tags, which contain a battery, and passive RFID tags, which have no battery.

RFID has been widely utilized for asset tracking or inventory controls, such as in inventory tracking for shipping and retail applications. This has historically been a passive RFID technology, where an RFID tag is powered by the energy transmitted from the reader when it sends a radio frequency (RF) transmission to the RFID tag to retrieve an embedded UPC code, serial number, or asset control number.

### BRIEF SUMMARY

RFID devices can be powered by one or more sources of RF energy, including available RF energy. RFID can be utilized to measure data, or receive data transmitted to the RFID device, and can preferably store the data and transmit the data to an RFID reader or other data receiver.

In one aspect, an RFID device is provided that includes an energy harvesting and storing system that receives available RF energy and uses the available RF energy to power the RFID device.

In another aspect, an RFID device is provided that includes an energy harvesting and storing system that receives available RF energy and uses the available RF energy to power the RFID device, a microprocessor connected to the energy harvesting and storing system, a transceiver connected to the microprocessor, and a data transmission antenna connected to the transceiver.

In a third aspect, an RFID device is provided that includes an energy harvesting and storing system that receives available RF energy and uses the available RF energy to power the RFID device, a microprocessor connected to the energy harvesting and storing system, one or more sensors connected to the microprocessor that can measure data, a transceiver connected to the microprocessor, and a data transmission antenna connected to the transceiver.

### BRIEF DESCRIPTION OF SEVERAL VIEWS OF THE DRAWINGS

Specific embodiments of the invention have been chosen for purposes of illustration and description, and are shown in the accompanying drawings, forming a part of the specification.

FIG. 1. is schematic diagram of one embodiment of an energy harvesting and storing system of an RFID device.

FIG. 2 is a schematic diagram of one embodiment of an RFID smart sensor device.

FIG. 3 is a diagram of one embodiment of an RFID smart sensor device.

### DETAILED DESCRIPTION

The RFID devices disclosed herein can be utilized to measure data, or receive data transmitted to the RFID device, and can preferably store the data and transmit the data to an RFID reader or other data receiver. In some examples, RFID devices can include one or more sensors that can measure data. In other examples, RFID devices can receive data transmitted from a remote data gathering device. In some examples, the RFID devices also include data logging capabilities, and can store data that corresponds to one or more data readings.

RFID devices of the present technology can be powered in any suitable manner. In at least some examples, RFID devices include an antenna that receives available RF energy, and the RFID device can thus be powered from a single source or a plurality of sources. For example, RFID devices described herein can be powered from one or more sources of available RF energy. The term “available RF energy” should be understood to encompass RF energy that is transmitted generally in the area of the RFID device, and is thus available to the RFID device, regardless of the source transmitting the RF energy, where such RF energy is not directed in a focused manner specifically to the RFID device. Conventional passive RFID technology relies upon RF energy directed from an RFID reader specifically to an RFID device. Instead, RF energy received by the present RFID devices can be collected from any available source of RF energy that is receivable by the RFID device. The RF energy received by the RFID device can thus be intercepted and collected from transmissions sent by one or more sources for purposes unrelated to powering the RFID device, including but not limited to, RF energy from commercial radio broadcasts on AM radio bands or FM radio bands, or broadcast television transmissions. In other examples, one or more dedicated transmitters can be utilized in an area that is local to the sensor, such as being within a radius of a few miles, or a smaller radius, such as for example, a radius of a few hundred feet, and can transmit RF energy that can be received by one or more RFID devices. Such dedicated transmitters can be licensed or un-licensed, and can operate on non-commercial bands. The dedicated transmitters can broadcast RF energy within the intended radius, and one or more RFID devices can receive the RF energy. The RF energy received by the RFID device can power the device to perform tasks of monitoring and reporting information from various types of sensors.

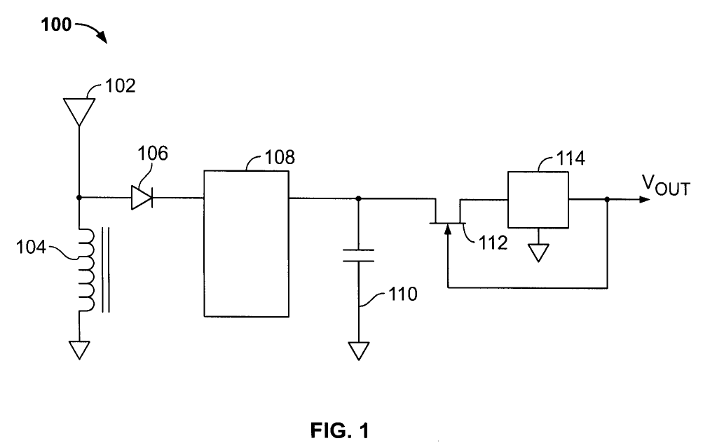

FIG. 1 illustrates an energy harvesting and storing system 100 that can be utilized in an RFID device. The energy harvesting and storing system 100 can receive available RF energy and use the available RF energy to power the RFID device. The system 100 can utilize ultra low power techniques to gather and store power derived from the available RF energy. The system 100 includes an RF receiving antenna 102 that receives RF energy, preferably available RF energy from one or more RF energy sources. The system 100 also includes at least one transistor 104, which forms a broadband tuner circuit with the RF receiving antenna 102. The at least one transistor 104 can preferably operate at voltage levels down to less than about 0.6 volts, including, for example, about 0.1 volts. RF energy collected by RF receiving antenna 102 can be provided to a diode 106 that converts the received RF energy to a DC voltage. The DC voltage as converted from the received RF energy can tend to be a low voltage, and can be in the range of from about 0.1 volts or greater. The DC voltage from the diode 106 can be boosted to a value high enough to run the RFID device using voltage doubling or tripling circuitry. For example, the DC voltage from the diode 106 can be provided to a charge pump 108, which can convert DC voltage to a higher DC voltage. In one example, the DC voltage can be increased by the charge pump 108 to a voltage of about 5 volts. The DC voltage produced by the charge pump 108 can be provided to a capacitor 110. Capacitor 110 can be a super capacitor that removes the ripple from the DC voltage as received from the charge pump and stores the DC voltage for use in powering the RFID device. In an alternative embodiment, capacitor 110 can be a low voltage capacitor that removes the ripple from the DC voltage as received from the charge pump, and the DC voltage can be stored in a super capacitor located elsewhere in the system. The system 100 can also include a transistor 112 and a regulator 114. The system 100 can provide a regulated DC voltage Vₒᵤₜ that can power the RFID device.

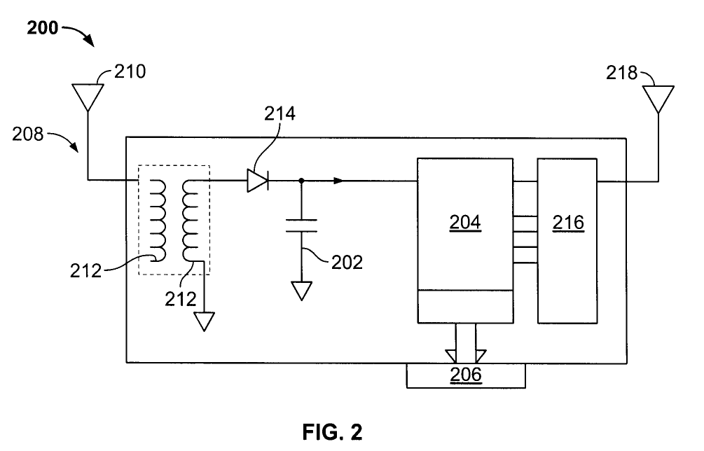

FIG. 2 illustrates an RFID device 200 that includes an energy harvesting and storing system. The energy harvesting and storing system can preferably store enough energy in at least one super capacitor 202 to allow a microprocessor 204 and at least one sensor 206 to activate periodically, take a measurement, store the value of the measurement, and later provide the stored data to a data receiver. As illustrated, RF energy 208 can be received by an RF receiving antenna 210. The RF energy can be received from at least one source of RF energy, and can be received from a plurality of sources of available RF energy. The received RF energy can be provided to one or more transistors 212. The received RF energy can be provided to a diode 214 that converts the received RF energy to a DC voltage. In some embodiments, as described with reference to FIG. 1 above, the DC voltage from the diode 106 can be boosted to a value high enough to run the RFID device using voltage doubling or tripling circuitry. The DC voltage can then be provided to and stored by the super capacitor 202.

As further illustrated in FIG. 2, the super capacitor 202 can provide power to the other components of the RFID device, which can include a microprocessor 204, at least one sensor 206, a transceiver 216, and a data transmission antenna 218. In at least one example, power from the super capacitor 202 can be utilized to periodically activate the at least one sensor 206. When activated, the at least one sensor 206 can measure data and provide the measured data to the microprocessor 204. The microprocessor 204 can utilize power received from the super capacitor 202 to perform any of a number of functions, including, but not limited to, converting the data from the at least one sensor 206 to a digital representation, storing the data, and transmitting the data through the transceiver 216 and the data transmission antenna 218. The data transmission antenna 218 transmit data from the RFID device to an RFID reader or other data receiver. Such transmissions can occur periodically, or upon receipt of a query or commend from the RFID reader or other data receiver.

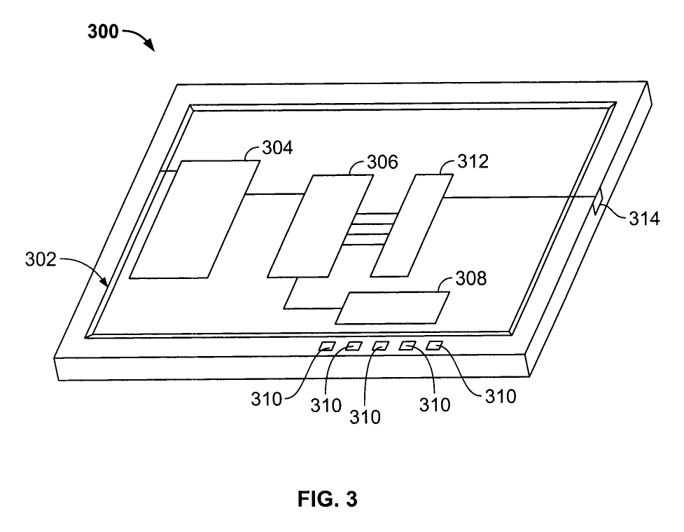

FIG. 3 illustrates an RFID device 300. The RFID device 300 includes a housing 302, an energy harvesting and storing system 304, a microprocessor 306, a sensor 308, a transceiver 312, and a data transmission antenna 314. The sensor 308 can measure data via one or more sensor portals 310 in the housing 302 of the RFID device 300.

RFID devices of the present technology may be used in the fields of monitoring, detecting, tracking, and reporting a specific sensor based parameter in the areas of electrical, chemical, biological, radiological, environmental, or intrusion sensing. Examples of these can range from chemical sensors useful in detecting the change in products that have a specific shelf life, to bio-sensors useful in monitoring biologically active products, to radiological sensors useful in detecting high radiation levels, to seismic sensors useful in detecting seismic activity, to implantable devices useful in monitoring blood sugar levels or other blood borne antigens, as well as to numerous other applications.

In one application, an RFID sensor device can be utilized for monitoring blood sugar levels. A rechargeable wrist reader can be utilized to provide RF energy to the body implantable RFID smart sensor device. The sensor in the RFID smart sensor device can activate periodically, such as every few hours or at other time intervals, to measure and store data relating to the blood sugar level of a patient. The RFID smart sensor device can be issued a command via RF from the wrist reader or from another command device, and can transmit the stored data to the wrist reader or other command device regarding the blood sugar levels of the patient.

In another application, an RFID sensor device can be utilized as a shelf life monitoring device. The RFID sensor device can be placed upon a shelf that contains perishable food items. The sensor in the RFID sensor device can activate periodically, such as daily or at other time intervals, to measure and store data relating to the status of the food items.

In a third application, an RFID device can receive and store transmitted data from a remote data measuring device, and can later transmit the stored data to a data receiving device. For example, livestock tagged with an RFID device can be weighed, and the weight data for each animal can be transmitted to, received by, and stored on the RFID device worn by the animal. The data can be stored over a period of time, and then can be transmitted to a data receiver to monitor and track the weight or health of the animal.

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

What is claimed is:

1. An RFID device comprising an energy harvesting and storing system that receives available RF energy and uses the available RF energy to power the RFID device.

2. The RFID device of claim 1, wherein the energy harvesting and storing system converts the available RF energy to DC voltage.

3. The RFID device of claim 2, wherein the DC voltage is stored in a super capacitor.

4. The RFID device of claim 1, wherein the available RF energy is received from one or more sources.

5. The RFID device of claim 4, wherein the available RF energy is received from a plurality of sources.

6. The RFID device of claim 4, wherein available RF energy is received from a commercial radio broadcast, a broadcast television transmission, or a dedicated transmitter.

7. The RFID device of claim 1, further comprising one or more sensors that can measure data.

8. The RFID device of claim 1, wherein the RFID device receives and stores data transmitted from a remote data measurement device.

9. An RFID device comprising:
an energy harvesting and storing system that receives available RF energy and uses the available RF energy to power the RFID device;
a microprocessor connected to the energy harvesting and storing system;
a transceiver connected to the microprocessor; and
a data transmission antenna connected to the transceiver.

10. The RFID device of claim 9, wherein the available RF energy is received from one or more sources.

11. The RFID device of claim 10, wherein the available RF energy is received from a plurality of sources.

12. The RFID device of claim 10, wherein available RF energy is received from a commercial radio broadcast, a broadcast television transmission, or a dedicated transmitter.

13. The RFID device of claim 9, further comprising one or more sensors that can measure data.

14. The RFID device of claim 9, wherein the RFID device receives and stores data transmitted from a remote data measurement device.

15. The RFID device of claim 9, wherein the energy harvesting and storing system converts the available RF energy to DC voltage.

16. The RFID device of claim 15, wherein the DC voltage is stored in a super capacitor.

17. An RFID device comprising:
an energy harvesting and storing system that receives available RF energy and uses the available RF energy to power the RFID device;
a microprocessor connected to the energy harvesting and storing system;
one or more sensors connected to the microprocessor that can measure data;
a transceiver connected to the microprocessor; and
a data transmission antenna connected to the transceiver.

18. The RFID device of claim 17, wherein the energy harvesting and storing system converts the available RF energy to DC voltage and the DC voltage is stored in a super capacitor.

19. The RFID device of claim 18, wherein DC voltage stored in the super capacitor is utilized to periodically activate the one or more sensors, and the one or more sensors measure data.

20. The RFID device of claim 10, wherein available RF energy is received from a commercial radio broadcast, a broadcast television transmission, or a dedicated transmitter.
